(19) United States
(12) Patent Application Publication
(10) Pub. No.: US 2017/0148124 A1
(43) Pub. Date: May 25, 2017

(54) RISK ASSESSMENT SYSTEM - EVIDENCE BASED

(71) Applicant: Michael D. Johnston, Boise, ID (US)

(72) Inventor: Michael D. Johnston, Boise, ID (US)

(21) Appl. No.: 14/946,296

(22) Filed: Nov. 19, 2015

(51) Int. Cl. G06Q 50/26; G06Q 10/00

(52) U.S. Cl. CPC G06Q 50/265; G06Q 10/00

(57) ABSTRACT

A system and method of evaluating risk to reoffend with criminal behavior. The system and method includes one or more tables of risk variables, and sources of information about an examinee, populating the tables with positive indications of risk variables, and weighing the sources of information of risk variables. Also included is a report of risk variables, conclusions, and recommendations. Each risk variable includes the sources and weighting of responses and sources that led to the conclusion or recommendation.

### TECHNICAL FIELD

The presently disclosed and claimed technology generally relates to systems and methods for predicting criminal behavior, and more particularly to systems and methods for evaluating the risk of an examinee repeating criminal behavior.

### BACKGROUND

There is a need to evaluate the risk of a particular person to repeat an act of criminal behavior. This often occurs in evaluating a person for parole from the penal system or in evaluating a person for sentencing from a judge or jury. It's a complicated process, with many sources of information. This can include an interview with the client himself; it can include psychological testing, hospital records, witness accounts from crime scenes, police reports, reports of past counselors, statements made to other prisoners, and many other sources of information. Within all of those sources of information may be bits of information that are important, but which can be lost in the evaluation process. There is so much information that it is difficult for an individual evaluator to maintain a clear memory of all the information, yet the primary method of evaluating this information is to read or review all of the available material and make a decision based on the mass of data that the evaluator can contain in his head. This results in conclusions and recommendations based on a Gestalt type summarizing impression. This can be a problem because there are so many sources of information, it's possible for an evaluator to forget or misremember certain data points, or forget to ask certain questions, or improperly correlate information. Because an evaluator's memory may not be perfect, these problems could greatly affect the conclusions and recommendations of an evaluation, and potentially lead to inaccurate information being communicated to attorneys, judges, juries, parole commissioners, or other legal decision makers.

Another problem with this kind of analysis is that it may be hard to justify a certain conclusion or recommendation. For example, this would occur in a courtroom setting when a defense attorney may question the evaluator's conclusion of the examinee's risk to reoffend being in part based on a heavily weighted risk variable. For instance, the risk variable may be that the examinee has attitudes that support criminal behavior. Because that risk variable is weighted heavily, it highly contributed in the examinee being classified as a high risk to reoffend with future criminal behavior, and consequently, potentially receiving a longer sentence or not being released on parole. The defense attorney may understandably demand that the evaluator justify his analysis. Unless the evaluator has some kind of system for sorting and weighting various risk variables, it may be difficult for the evaluator to point to the specific references which justify the conclusion being challenged. A system which utilizes an easily referenced comprehensive list of risk variables, which may be checked off as data from different sources of information come to the evaluator's attention, and immediately weighted according to the severity of the particular information, would be useful when justifying an evaluator's conclusion. This is particularly true in a world in which hot links in a digital document can easily be followed to find the source of a conclusion.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

The disclosed technology is a method as well as a system for evaluating and estimating the risk of a person to repeat criminal behavior. As a method, what is disclosed is a method which starts with the step of creating a table of known risk variables, which can be static or dynamic risk variables. This table is called a comprehensive table of risk variables. This table or list is used as a reference for creating a table or list of relevant risk variables for a specific client. (For this discussion, client and examinee are used interchangeably.)

The risk variables in the comprehensive table are identified in empirical research as being predictive of criminal reoffending. Determining if certain risk variables are present for a particular client is done by gathering and using all available information. Some of this information is obtained directly from an examinee, through the use of a step of conducting an interview with the examinee. The interview can be in various modes, such as filling out information on a piece of paper, on a computer screen, or it can be face to face and verbal with an examiner. Some of this information is obtained from collateral sources, which can include police reports, criminal history, witness statements, hospital records, character references, psychological testing, prior evaluations, and other sources of information about the examinee. Based on such information, the analyst determines which if any of the risk variables from the comprehensive table are present in a particular client. Known risk variables are considered for a particular client, and those which are applicable to a particular client are assembled into the table of risk variables for that client.

The creation of the comprehensive table of risk variables is a way to standardize the analysis process, and to make sure that an examiner does not forget to make note of risk variables as indications of their presence arise. This also solves the problem of an examiner trying to remember all of the information that he hears in an interview or reviews in collateral information. By establishing a comprehensive table of risk variables, the examiner consistently considers risk variables which are based on empirical research, and have been determined to be predictive of criminal reoffending. As client information related to these risk variables presents from any source, there is a place for the examiner to record it and note the source of the information. The weight of importance or severity of the source is also recorded, with some positive indications of a risk variable being more critical than other indications.

The comprehensive table of risk variables includes static risk variables which have been determined through empirical research to be predictive of criminal reoffending. The static risk variables are made up of the examinee's information which either is historical in nature or not changeable by the examinee. These include: age, history of criminal behavior, history of major mental illness, characteristics of prior victims, family of origin history, employment history, school history, affiliation history, and other information which are pertinent to a particular examinee. The comprehensive table of risk variables also includes a table of dynamic risk variables which have been determined through empirical research to be predictive of reoffending. Dynamic risk variables are typically aspects or characteristics of the examinee that are unlikely to change without intervention, but could potentially change with intervention. These include: anger issues, poor impulse control, poor insight, substance use issues, victim blaming, minimization of criminal behavior, attitudes supporting criminal behavior, beliefs that support the manipulation of others, rejection of treatment, rejection of supervision, and other information which is pertinent to a particular examinee.

After creating a comprehensive table of risk variables, the next step involves populating the table of risk variables for a particular examinee. This step of populating the table uses information from the examinee's interview as well as from all collateral information sources. As a positive indication for a particular risk variable is encountered for a particular examinee, the indication is noted, and the risk variable is noted, along with the source and weight of the indication.

While populating the client table of risk variables, an examiner can immediately consider the importance or severity of the risk variable as represented by the presenting source of information, and immediately record a weighting score that represent how the examiner chose to weight the particular source of information. For instance, continuing with the above example, one of an examinee's risk variables may be that the examinee exhibits attitudes that support criminal behavior. There may be several pieces of information which support the conclusion that this is a risk variable for the examinee. This may be found in police reports, in the interview with the examinee, in the examinee's criminal history, in psychological testing, or in the behavior displayed in the examinee's criminal offense for which he is being evaluated. An examiner may consider the examinee's criminal history to be a strong indication that the examinee has attitudes that support criminal behavior, and record a heavy weight for that source. The examiner may conclude that the interview with the examinee suggests attitudes supporting criminal behavior, but that the suggestions were mild, and consequently, weight that source of information more lightly. And, the examiner could conclude police reports, psychological testing, and the behavior displayed in the examinee's recent criminal offense to all be moderate indications that the examinee has attitudes supporting criminal behavior, and weight all those sources moderately.

After the table of risk variables for a client has been populated, and each presenting risk variable has had all the sources of information identified and weighted, the examiner could easily review each identified risk variable, consider the collective weight of all the presenting sources, and determine a ultimate weight of severity and importance for each particular risk variable.

Next, the examiner can easily review a cumulative list of all the presenting risk variables, followed by considering their respective ultimate weights of severity and importance, and use this well organized source of detailed, comprehensive, and empirically based information to assist in making the conclusion of an examinee's risk to reoffend, along with associated recommendations. This would not only make the evaluation and conclusions more standardized, but would also make the evaluation and conclusions less subject to error and criticism, in addition to making them easier to defend, justify, explain and understand. Because the examiner is basing his conclusions and recommendations on risk variables that are supported by empirical research, the conclusions and recommendations are “Evidence Based”. All these advantages promote organization, consistency, accuracy, transparency, and a system that allows an evaluator to easily explain and justify conclusions and recommendations.

This information would be detailed in a report for a particular client. With digital documents, the report could include hot links to the data sources, and would be available for rigorous questioning in court, allowing the examiner to easily reference the presenting risk variables, easily reference the sources of information that lead to the determination that the risk variables were present, easily reference the weighting of each source of information, and explain to members of the court the reasoning involved in the evaluation process.

A unique quality of this system is that during the interview with the examinee the questions that will appear on the computer screen or paper history forms are structured and consistent. Every examinee will be presented with the same questions, in the same format, allowing for organized consistency that minimizes error and minimizes the chance of an examiner failing to ask important questions that relate to risk variables. The organizational quality of this method allows fora follow-up verbal interview based on the examinee's responses to the computer or paper questionnaire which can be grounded in structure as so the verbal interview is addressing the relevant information for identifying risk variables, and again minimizing interviewing error. Furthermore, having questions initially asked through a computer screen or paper forms eliminates the possibility that an examinee could have their initial responses contaminated by the examinee in part basing his answers on the examiner's body language, tone, or demeanor. Contamination would be less likely to occur in a follow-up verbal interview, as the examinee's answers would already be established through the computer or paper questionnaire. The organizational qualities of this method and prevention of contaminated responses collectively would improve the evaluation process and lead to more accurate information on risk variables, and consequently, more accurate conclusions and recommendation.

The system can also include a comprehensive table of acute dynamic risk variables, which are risk variables that have been shown through empirical research to be predictive of reoffending. Acute dynamic risk variables are those that can can suddenly develop, but be temporary and reversible. They can rapidly increase an examinee's risk to reoffend. Acute dynamic risk variables may be identified directly from an interview with the examinee or obtained from collateral sources. Acute dynamic risk variables can include: access to potential victims, surges in hostility, collapse of social support, active abuse of substances, and other information which are pertinent to a particular examinee. The comprehensive table of acute dynamic risk variables provides a checklist for the development of a client specific table of acute dynamic risk variables.

The system can also include a comprehensive table of protective variables, which are variables that reduce risk of reoffending. Protective variables commonly contribute to the stability of an examinee, relate to his compliance with supervision, and relate to his compliance with treatment, suggesting a lower likelihood that he would return to inappropriate criminal behavior. Protective variables can include: absence of a serious criminal history, pro-social attitudes, good social skills, financial responsibility, a positive employment history, skills at managing emotions, successful completion of treatment, successful completion of probation/parole, and other information which are pertinent to a particular examinee. The comprehensive table of protective variables provides a checklist for the development of a client specific table of protective variables.

The system can also include a glossary of terms that defines all of the risk and protective variables, in addition to industry terms in the report. The purpose of this glossary is to further minimize error, as it's a reference for not only the examiner, but also for people reading the report, including judges, attorneys, probation officers, parole officers, treatment providers, court officials, and others. By having definitions readily available for all terms, there is a lower likelihood of misinterpretation, and consequently, a lower likelihood of error and less likelihood of the results being challenged.

The system can also include a reference to the research that supports the risk variables being predictive of reoffending, and protective variables reducing the likelihood of reoffending. This provides clarification regarding the reasoning of why the variables are being considered by the examiner, what the source of each indication is, and why the consideration of the variables leads to accuracy of conclusions and recommendations produced by the method. The reference to sources can be a hot link in a digital display of the report, or can be a footnote type reference in a paper version of the report. Identifying the research that supports risk variables, protective variables, conclusions, and recommendations, creates an “Evidence Based” report that is more likely to be understood, more likely to be accurate, and less likely to be challenged.

### BRIEF DESCRIPTION OF THE DRAWINGS

FIG. 1 is a flow diagram of the overall method or system of the disclosed technology.

FIG. 2 is a continuation of the flow of steps shown in FIG. 1, ending with populating a report.

FIG. 3 is a flow diagram of the analysis portion or step of the method or system of the disclosed technology.

FIG. 4 is a flow diagram of the reporting portion or step of the method or system of the disclosed technology.

FIG. 5 shows more information contained in the report.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

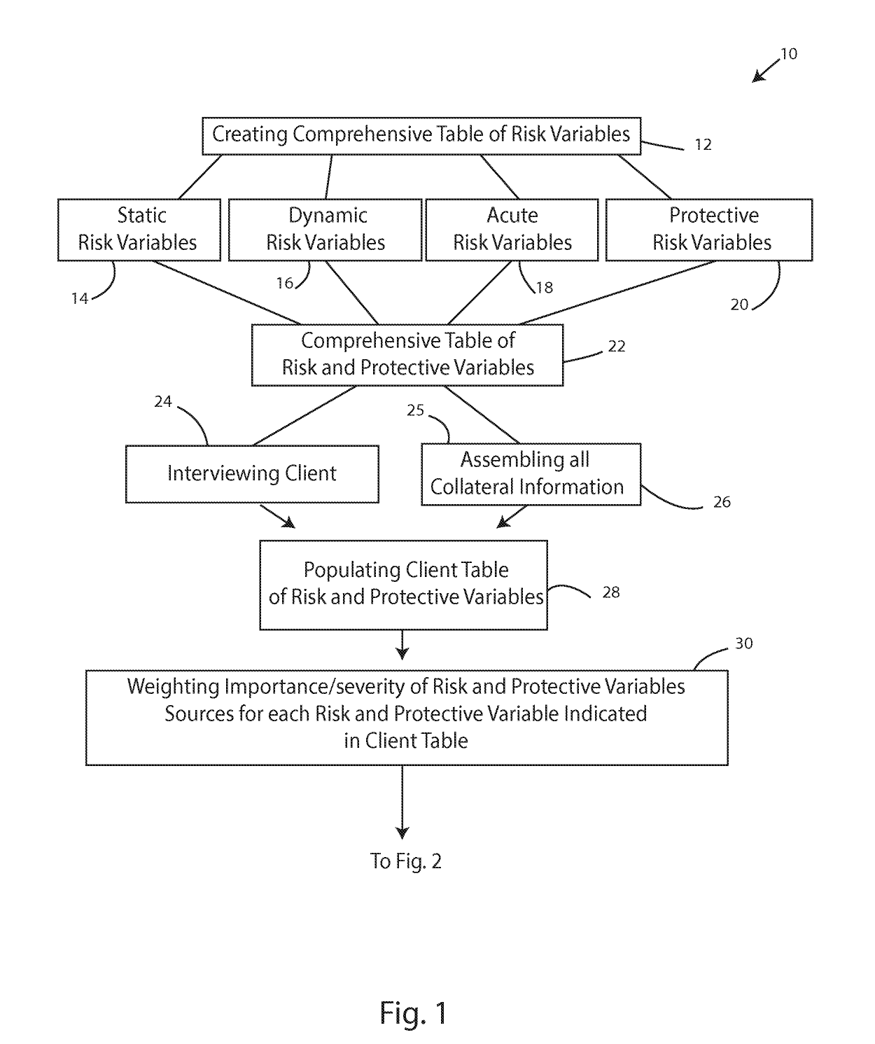

Shown in FIG. 1 is a flow diagram of the method of the system which is designated 10. Shown at 12 is the first step of the method 10, which is the step of creating a comprehensive table of risk and protective variables. Shown below step 12 are the types of risk variables and protective variables which are possible. These include static risk variables 14, dynamic risk variables 16, acute risk variables 18 and protective variables 20. Known examples of these types of risk and protective variables are added to a comprehensive table of risk and protective variables 22.

Static risk variables are historical events or characteristics of the examinee that cannot be changed or adjusted through treatment, and have been identified through empirical research to increase risk to reoffend.

The following is a list of static risk variables, shown to illustrate this type of risk variable. This list is not to be considered all inclusive. As research continues, the list would be modified to include the discovery of new static risk variables or modifications to existing static risk variables. The table or checklist is intended to provide structure and guidance to the analysis of an examiner, allowing the examiner to root his conclusions and recommendations in empirically-based static risk variables that allow for greater accuracy. An examiner would review a comprehensive table of risk and protective variables, including these static risk variables, as they review each source of information on an examinee, and identify static risk variables as they present. In this way they would end up with a client specific table or list of risk and protective variables. As soon as the examiner identifies evidence of a static risk variable from a particular source of information, the source of information would be recorded, along with the weight to which the examiner assigns for that particular source of information.

Offender's Age Under 35

History of Paraphilia(s) -or- Sexual Deviancy -or- Sexual Functioning Issues

History of Impulsiveness -or- Recklessness

History of Major Mental Illness -or- Personality Disorder -or- Schizophrenia

History of Substance Use Issues as an Adolescent

History of Substance Use Issues as an Adult

Having Ever had a Sexual Victim that was Not Related

Having Ever had a Sexual Victim that was a Stranger

Having Ever had a Sexual Victim that was a Male

Having Prior Charges for Sexual Offenses -or- Prior Conviction for a Sexual Offense

History of High Density of Sexual Offending

High density refers to multiple incidents of sexual offending with in a short period of time.

History of a Conviction for a Non-Contact Sexual Offense

History of Multiple Sexual Offense Behaviors and Types

This risk variable relates to an examinee engaging in multiple different types of sexual offenses. This can include the examinee engaging in two or more of any of the following different types of sexual offenses: exhibitionism, voyeurism, enticement, possession of child sexual abuse images, physical sexual contact with a victim, or others.

History of Grooming a Sexual Abuse Victim

History of Childhood Aggression or Violence Problems Prior to Age of 15

History of Aggression or Violence At and/or After Age 15 (Including Adulthood)

Victim Being Physically Injured in the Course of the Sexual Offense

Use of a Weapon or Threat of Death Occurring During the Sexual Offense

History of Family of Origin Instability Associated with the Offender Not Living with Parents until Age 16

History of Family of Origin Instability Associated with Family Member(s) having Mental Illness and/or Substance Use Issues

History of Family of Origin Instability Associated with Family Member(s) having Antisocial or Criminal Issues

History of Family of Origin Instability Associated with the Offender Witnessing Abuse of Other Family Member(s)

History of the Offender Experiencing Abuse (Physical, Emotional, or Sexual)

Offender Having No History of a Long Term Committed Romantic/Sexual Relationship

History of Antisocial Influences or Affiliations

History of Problems with School Performance

History of Employment Issues

History of Discipline Issues in Elementary School (1^{st} through 8^{th} Grade)

History of Discipline Issues in High School (9^{th} through 12^{th} Grade)

Displaying Antisocial Behavior Prior to the Age of 15

Displaying Antisocial Behavior At and/or After Age 15 (Including Adulthood)

Having a Prior Arrest History

History of Discipline Issues While Incarcerated

History of Psychopathy

History of Treatment Failure

History of Supervision Failure

Dynamic risk variables are referred to as “dynamic” due to their ability to change. Generally, dynamic risk variables are unlikely to change without some form of intervention, most commonly treatment. Dynamic risk variables have been identified through empirical research to increase risk to reoffend.

The following is a table or checklist of possible dynamic risk variables, and would be incorporated into the comprehensive table of risk and protective variables. This list is not to be considered all inclusive or finalized. As research continues, the list would be modified to include the discovery of new dynamic risk variables or modifications to existing dynamic risk variables. The checklist is intended to provide structure and guidance to the analysis of an examiner, allowing the examiner to root his conclusions and recommendations in empirically-based dynamic risk variables that allow for greater accuracy. An examiner would review this table or checklist as they review each source of information on an examinee, identify dynamic risk variables as they present, and form a client specific table of risk and protective variables. Also, as soon as the examiner identifies evidence of a dynamic risk variable from a particular source of information, the source of information would be recorded, along with the weight to which the examiner assigns for that particular source of information.

Unstable or Untreated Major Mental Illness -or- Personality Disorder -or- Schizophrenia

Negative Mood -or- Anger Issues

Poor Emotional Regulation

This risk variable refers to an offender having difficulty controlling his emotions.

Poor Impulse Control

Fragile Narcissism

This risk variable refers to an offender having narcissistic tendencies that lead them to be vulnerable to easy offence or upset by other people's behaviors or comments, even when those behaviors and comments are ones that most people would not find offensive, or only find mildly offensive. Also, the offender would be more likely to have intense responses including inappropriate behavior.

Poor Insight

This risk variable refers to an offender demonstrating poor understanding of their psychological functioning, and why they experience particular moods, thoughts, or display particular behaviors. Consequently, they have a more limited ability to control their moods, thoughts, and behavior.

High Stress Lifestyle

This risk variable refers to an offender experiencing more stress than most individuals, and their stress being associated with their lifestyle. Lifestyle could include their choice in job, relationships, recreational activities, or other lifestyle choices.

Unstable or Untreated Substance Use Issues

Unstable or Untreated Paraphilia(s) -or- Sexual Deviancy -or- Sexual Functioning Issues

Emotional Congruence with Children

This risk variable refers to an offender emotionally identifying with children, and relating with children on emotional levels, possibly including preferring the company of children over adults, and potentially perceiving children as peers.

Attitudes that Support Sexual Offending

This risk variable refers to an offender having a belief system that supports engaging in sexual offenses. This is commonly seen as the offender justifying or minimizing their sexual offenses, but can include many other aspects of the offender's attitude toward sexual offending. Examples include a rapist believing women want to engage in sexual activity even when women say no, or a child molester believing that engaging children in sexual behavior helps teach children to be better lovers as adults.

Adversarial Sexual Beliefs

This risk variable refers to an offender perceiving sexual activity as an adversarial relationship. This could include the offender viewing sexual activity as a game, where a male and female compete over whether or not sex will occur. At the core of this risk variable, the offender associates adversarial tendencies with sexual behavior.

Sexual Entitlement

This risk variable refers to an offender believing he is entitled to sex. There are many different potential variations of this risk variable, and could include an offender believing a woman owes him sex after taking her out on a date, or that a woman who chooses to dress provocatively should not resist sexual activity.

Sexual Preoccupation

This risk variable refers to an offender being preoccupied with sexual activity, and commonly hypersexual. This could include excessive masturbation, frequent visiting of strip clubs, excessive pornography viewing, or turning to sexual partners for sexual interactions at a frequency that is beyond a typical person.

Sex as a Method for Coping

This risk variable refers to an offender utilizing sexual behaviors as a way to cope with stress. This can include an offender utilizing pornography viewing, masturbation, sexual interactions with a sexual partner, or other sexual behaviors as ways to deal with stressful events in life.

Significant Minimization of a Sexual Offense

Victim Blaming

Escalation in Frequency or Severity of Sexual Offense Behavior when last Having Opportunity to Commit a Sexual Offense

Loneliness or Social Rejection

Relationship Instability

This risk variable refers to an offender having within their current relationship frequent arguments, frequent breakups, infidelity, and ongoing animosity.

Problems Developing and/or Maintaining Pro-social Relationships

This risk variable refers to an offender having difficulty forming relationships with people who represent pro-social behavior. Pro-social behavior includes activities and a lifestyle that facilitates a healthy society, including obeying laws, following rules, maintaining employment, paying bills, being respectful, and behaving in responsible ways.

Problems Avoiding Negative and/or Antisocial Relationships

This risk variable refers to an offender having difficulty avoiding people who are negative influences, or endorse antisocial behaviors. This could include people who engage in criminal activity, engage in substance abuse, glorify violence, justify sexual abuse, believe in the exploitation of others, or minimize the offender's inappropriate behavior.

Hostile Beliefs toward Women

This risk variable refers to an offender believing women deliberately create trouble for men, believing women deliberately harm men, having desires to hurt women, objectifying women, sexualizing women, having strong chauvinistic attitudes that belittle women, or having other negative attitudes towards women.

Insufficient Fear of Punishment or Consequences

Pride in Delinquent or Antisocial Behavior

Failure to Recognize Risk to Re-offend

Callousness or Lack of Concern for Others

Beliefs that Support the Manipulation of Others

Attitudes that Support an Antisocial Lifestyle

Propensity to Break Rules

Poor Problem Solving Skills

Negative Attitudes Towards Treatment -or- Unresponsiveness to Treatment -or- Rejection of Treatment

Negative Attitudes Towards Supervision -or- Unresponsiveness to Supervision -or- Rejection of Supervision

Lack of Feasible Plans to Prevent Re-offending

Acute dynamic risk variables are risk variables that can suddenly develop, but be temporary and reversible. Acute dynamic risk variables have been identified through empirical research, and can rapidly and potentially dramatically increase an examinee's risk to reoffend.

The following is a checklist of acute dynamic risk variables. This list is not to be considered all inclusive. As research continues, the list would be modified to include the discovery of new acute dynamic risk variables or modifications to existing acute dynamic risk variables. This table of acute dynamic risk variables would be incorporated into the comprehensive table of risk and protective variables. The checklist is intended to provide structure and guidance to the analysis of an examiner, allowing the examiner to root his conclusions and recommendations in empirically-based acute dynamic risk variables that allow for greater accuracy. An examiner would review this checklist as they review each source of information on an examinee, identify acute dynamic risk variables as they present, and develop a table of client specific risk and protective variables. As the examiner identifies evidence of an acute dynamic risk variable from a particular source of information, the source of information would be recorded, along with the weight to which the examiner assigns for that particular source of information.

Victim Access

This risk variable refers to an offender having opportunity to access a potential victim coupled with evidence of their either planning to engage a potential victim or grooming a potential victim.

Hostility

This risk variable refers to an offender making threats, making revenge statements, or having physical outbursts.

Sexual Preoccupations

This risk variable refers to an offender having an increase in masturbation frequency, strong sexual urges, frequent porn viewing, or frequent visiting of strip clubs.

Rejection of Supervision

This risk variable refers to an offender avoiding supervision, breaching conditions of supervision, lying, or absconding.

Emotional Collapse

This risk variable refers to an offender experiencing emotional collapse, and consequently, experiencing suicidal ideation, homicide ideation, compulsions to act on paranoid thoughts, or impulsiveness.

Collapse of Social Support

This risk variable refers to an offender experiencing loss of positive social support and/or engaging negative social influences.

Acute Substance Use Issues

This risk variable refers to an offender placing himself in uninhibited states through drug or alcohol use.

Protective variables are those variables that contribute to the stability of an examinee, his compliance with supervision, and his compliance with treatment, suggesting a lower likelihood that he would return to inappropriate criminal behavior. Protective variables are actively being researched, but presently are not as well defined in the empirical research as risk variables.

The following is a table or checklist of protective variables. This list is not to be considered all inclusive. As research continues, the list would be modified to include the discovery of new protective variables or modifications to existing protective variables. These protective variables would be part of the comprehensive table of risk and protective variables to be considered in forming a client specific table of risk and protective variables. The checklist is intended to provide structure and guidance to the analysis of an examiner, allowing the examiner to root his conclusions and recommendations in protective variables that allow for greater accuracy. An examiner would review this checklist as they review each source of information on an examinee, identify protective variables as they present, and develop the client specific table of risk and protecitve variables. Also, as soon as the examiner identifies evidence of a protective variable from a particular source of information, the source of information would be recorded, along with the weight to which the examiner assigns for that particular source of information.

Presenting as Functioning Well in an Employment Setting

Presenting as Functioning Well in a School Setting

Presenting with Financial Responsibility

Presenting with Ongoing Sobriety for One Year or Longer

Presenting with Long Term Sobriety for Ten Years or Longer

Presenting with a Current Satisfying and Appropriate Sexual Relationship

Presenting with a Current Romantic Relationship that is Functioning Well

Presenting with a History of a Prior Functional Long Term Committed Romantic/Sexual Relationship

Presenting with Pro-social People in Support Network

Presenting with a Support Network Effective at Reducing Stress

Presenting with the Ability to Avoid Negative Relationships

Presenting with Pro-social Attitudes

Presenting with a Positive Attitude Toward Treatment

Presenting with Successful Completion of Treatment

Presenting with the Skills and Ability to Manage Emotional Issues

Presenting with a Positive Attitude Toward Supervision

Presenting with Successful Completion of Supervision

Presenting with Propensity to Engage in Healthy and Pro-social Recreational Activities

Presenting with Recreational Activities that are Effective at Reducing Stress

Age Over 40

Age Over 60

Presenting with No History of Violence -or- Aggression

Presenting with No Prior History of Sexual Offense Behavior

Presenting with No Prior Arrest History or a Very Limited Arrest History

Presenting with No History of Abuse (Physical, Emotional, or Sexual)

Presenting with a Stable Childhood with No Family History of Psychological or Substance Use Issues

Presenting with No History of a Family with Criminal -or- Antisocial Issues

Presenting with a Family that Represents Pro-social Behaviors

Presenting with No History of Discipline Issues in School

Presenting with No History of Problems with School Performance, Grades, Peer Interactions in School, or Completion of School

Presenting with No History of Treatment Failure

Presenting with No History of Supervision Failure

Presenting with No History of Substance Use Issues

Presenting with No History of Serious Mental Health Issues

Presenting with No History of Impulsiveness -or- Recklessness

After the step of creating a comprehensive table of risk and protective variables, other steps proceed to evaluate a specific client for information indicating any risk and protetive variables that are in the comprehensive table. A table of risk and protective variables for a specific client or examinee is thus developed, at step 28.

At step 24 is the step of presenting questions in an interviewing to an examinee, for the purpose of evuation for the presence of risk and protective variables. Questioning an examinee can take the form of presenting the examinee with a questionnaire designed to identify information useful for the examiner to draw conclusions regarding the presence of risk variables or protective variables. This questionnaire may use a computer screen or paper format, presenting the examinee with questions, and allowing the examinee to respond by striking the appropriate key on a key board, typing answers on a keyboard, checking boxes on a sheet of paper, filling in bubbles on a sheet of paper with a number 2 pencil mark for automated reading, or handwriting answers on a sheet of paper. Questioning an examinee can also take the form of a face-to-face interview with the examinee, asking the examinee to explain information he self-reported, or explain information that presented in collateral sources, which could include a police reports, an interview with a victim, psychological test results, hospital records, or in other sources. The interview can take the form of an interactive video, with the image of a person asking the examinee to verify or explain the self reported information. All of these forms of questioning the examinee are designated an interview, and various combinations of these formats of an interview can take place in different embodiments of the system.

Step 26 is the step of collecting and analyzing collateral information. Colatteral information can include police reports, criminal history, witness statements, hospital records, character references, psychological testing, prior evaluations, and other sources of information about the examinee.

Step 28 is the step of populating a Client Table of relevant risk and protective variables, which is a subset of the comprehensive table of risk variables and protective variables. The examiner populates a client table of risk and protetive variables by analyzing the information obtained from the interview described above, and from all available collateral sources, with the intent of identifying the presense of certain risk variables or protective variables from the comprehensive table. This step of populating a client table of risk and protective variables takes place as information becomes known to the examiner from whatever source, and is a continual process as information is learned by the examiner. During the analysis process, the examiner references the comprehensive table of risk variables and protective variables, and as relavent information presents from all components of the analysis of the interview with the examinee and analysis of collateral sources, the examiner identifies the presence of relevant risk and protective variables for a particular examinee.

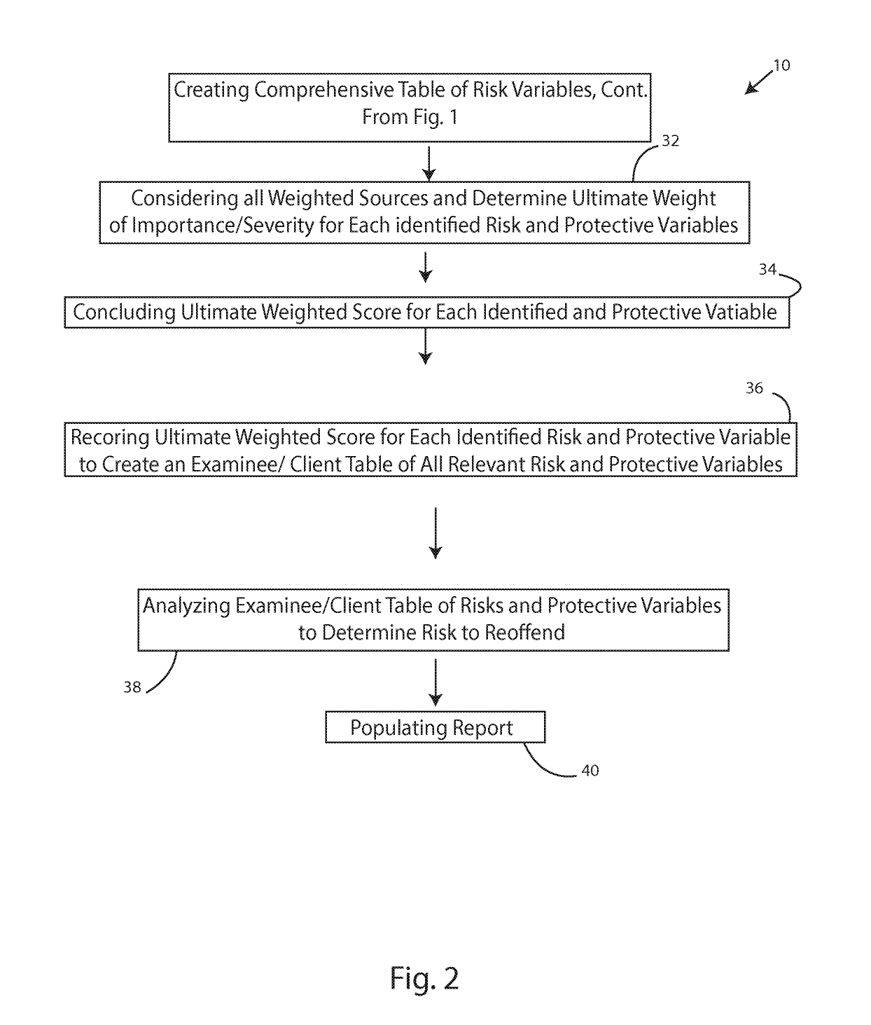

After a risk variable or protective variable is identified for a particular examinee, the next step occurs at step 30, where the examiner analyzes each source of information for each risk and protective variable. The source could be from an interview with the examinee, or any piece of relevant collateral information. After each risk and protective variable source is analyzed, the next step occurs at step 32, where the examiner assigns a weighted score representing the importance and/or severity of each source of information for each identified risk and protective variable source, as some sources would be more significant than others. At 34, the examiner records each weighted source, to create an easily reference list of all relevant sources, and their respective weighted scores. FIG. 2 continues the process begun in FIG. 1.

At step 36 of FIG. 2, after each risk variable and protective variable has been identified and each source of information that supports the presence of the particular risk variable or protective variable have been weighted, all the weighted identified sources of information for the respective risk variable or protective variable are collectively considered to determine a cumulative ultimate weighted score for each identified risk variable and protective variable. At step 38 the examiner records the ultimate weighted score for each identified risk and protective variable, resulting in an examinee/client table, or specific list of all the relevant risk and protective variables for the examinee, and ultimate weighted level of importance/severity of all variables, allowing the examiner to readily and easily understand all of the relevant historical events, circumstances, and characteristics that both increase and decrease an examinee's risk to reoffend, as so the examiner can consider this pertinent information in determining an examinee's risk to reoffend. Each risk and protective variable can be assigned a numerical score, such as 0-5, 0-100, etc. They can also be assigned descriptive terms such as “no evidence”, “mild evidence”, “moderate evidence”, “high evidence”, “severe evidence”, or “profound evidence”. Use of the numerical system does not imply that the ultimate weighted score for the risk or protective variables could ever be averaged to determine the examinee's risk to reoffend. For example an examinee who presents with 5 protetive variables that all receive low weighted scores, such as all 1's, would not necessarily cancel out 1 risk variable that received the highest weight, such as 5. This is so because the numbers do not represent equal and sequential mathematical units. Each risk and protective variable is not at it's base equal. Some risk variables are inherently more concering than others, and some protective variables are more powerful than others. For example, a person who has moderate sociopathic tendencies (risk variable) would usually be more concerning than a person who has severe substance use issues (risk variable). A person who had some difficulty but successfully completed several years of treatment associated with their criminal behavior (moderate weighted proective variable because of struggles) may be considered less likely to reoffend than a person who has been in a long tern stable romantic relationship of ten years (highly weighted protective variable because of duration and stability of the relationship). The purpose of the numerical score is to provide the examiner a structured process to systematically consider the varying importance of each respective risk and protective variable, and through this structure assist the examiner in determining an accurate conclusion regarding the examinee's risk to reoffend, in addition to providing a means to communicate to the individuals reading the report the logic and rational applied when the examiner derived his conclusions regarding risk to reoffend, and associated recommendations.

At step 40 the examiner analyzes all of the identified risk and protective variables, and their ultimate weighted scores, and collectively considers this succinct, specific, comprehensive, and research-based information to determine an examinee's risk to reoffend with the criminal behavior being analyzed.

It should be noted this system also allows the examiner to communicate not just an examinee's risk to reoffend, but the nature of the potential future offense, and overall potential threat an examinee could have to the community. This would be relavant to judges determining sentencing, probation or parole officers supervising an examinee, or treatment providers treating an examinee. If an examinee is being evaluated to determine the risk of their reoffending with some form of petit theft, and the risk of reoffending is high, that might be considered much less alarming than an examinee with a moderate risk of repeating an offense associated with violence.

Another benefit of this method is that it helps to eliminate bias. For example, this system would make it much more difficult for an examiner to base his conclusions on personal opinions or personal agendas, which could include desires to please a referral source (prosecuting attorney or defense attorney), political beliefs, religious beliefs, or personal experiences (this could include an evaluator having been a victim of violence, having been a victim of a sexual assault, having been a perpetrator of criminal behavior similar to that they are evaluating, or having a close relationship with somebody who engaged in criminal behavior similar to that they are evaluating). For example, if a prosecutor wants a severe sentence and consequently desires an evaluation that indicates an examinee is a high risk to reoffend, or if a defense attorney wants a light sentence and consequently desires an evaluation that indicates an examinee is a low risk to reoffend, the examiner could be biased toward justifying a conclusion regarding high or low risk to reoffend, and engage in an evaluation that does not consider all risk and protective variables, in addition to possibly considering personal beliefs of the examiner that have not been supported by research. Without the structure that this system provides in the evaluation process, if the examiner is question about their conclusions, they may simply rationalize their conclusions with statements such as “that's my opinion” or “based on my experience I draw these conclusions.” The structure of the system requires the examiner to consider evidence-based (research-based) risk and protective variables, and prevents conclusions being bias and simply based on the examiner's conclusory statement, “that is my opinion.” With this system, an attorney who suspects bias would be able to question the examiner regarding why risk or protective variables were or were not considered, or why risk and protective variables were weighted with either low or high levels of severity/importance. For example, a conclusion could in part be basaed on an examiner in a biased way misrepresenting the severity of the risk variable attitudes that support criminal behavior. If the examinee has had 100 arrests, and the examiner provides a low weight to attitudes supporting criminal behavior, a prosecuting attorney would be able to question the examiner's rationale. In contrast, if an examinee has one arrest for petit theft, and the examiner provides a high weight to attitudes supporting criminal behavior, a defense attorney would be able to question the examinee's rationale. Without the structure this system provides, an examiner who attempts to minimize an examinee's criminal history may simply not ask any questions of the examinee about their criminal history, or an examiner who attempts to exaggerate the examinee's risk to reoffend may ask questions or rely on information that's not supported by research. Without this system, it would be far more difficult for prosecuting and defense attorneys to determine how an examiner implemented their bias and ask relevant questions to illustrate the bias.

In addition to minimizing bias, this system would be most useful when identifying the risk to reoffend in complicated cases. If an examinee has very few low weighted risk variables and many high weighted protective variables, then an accurate conclusion using almost any system determining risk to reoffend is not difficult. In contrast, if an examinee has many high weighted risk variables and few low weighted protective variables, again an accurate conclusion with any system is not difficult. But, if an examinee has several medium weighted risk variables, and medium weighted protective variables, in addition to some low and high weighted risk and protective variables, a careful review of their sources and weightings becomes more critical for a reasoned conclusion. The detailed recording of sources and weightings allows questioning by a defense attorney, or by a prosecutor, and provides the judge with documented information to clearly understand the conclusions of the examiner, and support a determination of an appropriate sentence, appropriate treatment, and appropriate supervision of an examinee.

At box 42, the next step is populating a report which lists identified risk variables for the examinee, identified protective variables for the examinee, all the sources of information that are used to determine the presence of the risk variables and protective variables, all the weightings for each sources of information, and the ultimate weighted scores for each risk variable and protective variable, in addition the the examinee's risk to reoffend. The ultimate weighted score may be numerical or descriptive, but the numbers are not averaged together, rather they represent the severity and importance of the respective risk and protective variable as a structured process to allow for an accurate conclusion regarding an examinee's risk to reoffend. The report could also include an evaluation of the nature of the crime to be repeated, and the parties potentially harmed by a reoffence.

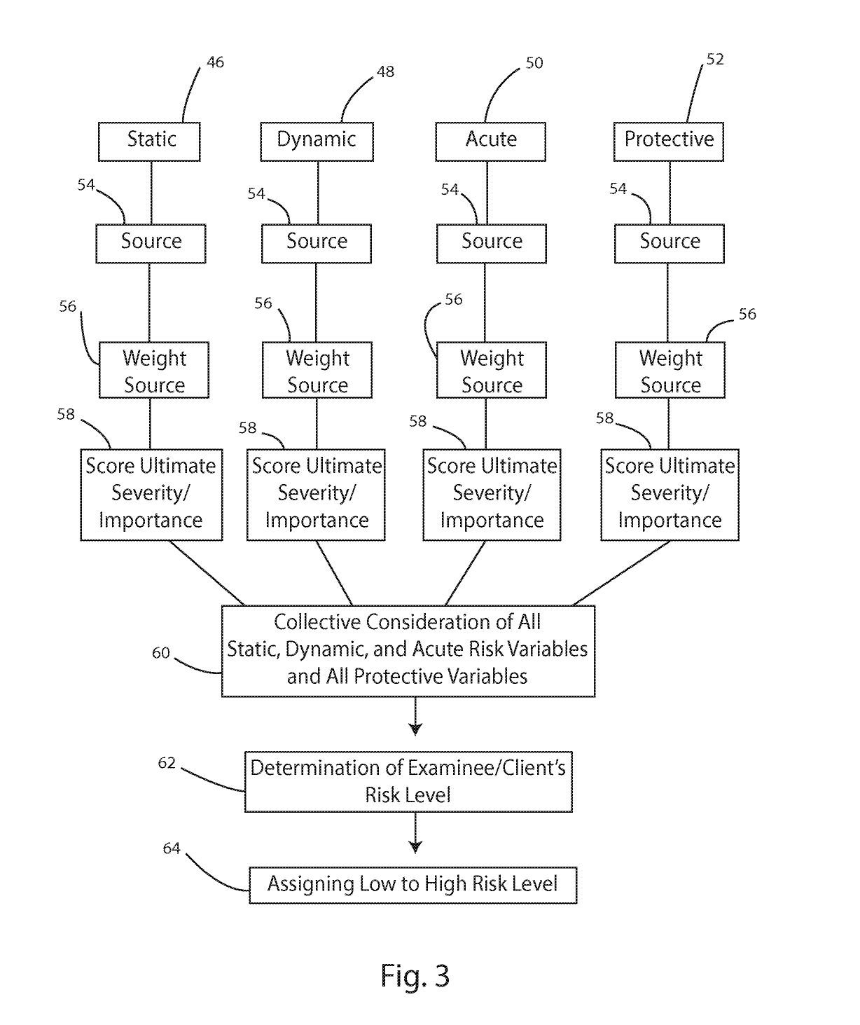

FIG. 3 shows the step 46 of analyzing static risk variables, the step 48 of analyzing dynamic risk variables, the step 50 of analyzing acute dynamic risk variables, and the step 52 of analyzing protective risk variables. For each of these types of variables, the sources for each specific variable is noted at 54, and a weight for each source is developed at 56. This process is repeated until all sources for each risk and protective variable have been identified and weighted. Then, the ultimate weighted score of the respective risk or protective variable is developed at 58, based on all weighted sources being considered for each risk and protective variable. This is repeated until all risk and protective variables have received their ultimate weighted score, representing the ultimate severity and importance of the risk or protective variable, based on consideration of all sources and their respective weights.

A lower score at 56 might result if the source only weakly implied that the source suggested the presence of the risk or protective variable, and a higher score at 56 might result if the source strongly implied the presence of the variable. For example, if an examinee was being assessed for the risk variable attitudes that support criminal behavior, and had the source of a criminal history with one prior arrest for theft, this would weakly suggest the presence of this risk variable, and examinee's criminal history as a source would receive a low weight. However, if an examinee presented with 40 prior arrests for numerous different crimes including violence, crimes against property, and drug offenses, spanning the past 20 years of the examinee's life, this would strongly imply attitudes that support criminal behavior and in this case the examinee's criminal history as a source would receive a high weight.

A score is assigned at 58 representing the cumulative consideration of all the sources for the particular risk or protective variable, and all of the weightings for each source. A lower score at 58 might result if there are only one or two sources that suggest a risk or protective variable was present, and these sources only weakly suggested the existence of the variable. A higher score might result if many sources suggest the risk or protective variable was present, or one or two sources strongly suggested the existence of the variable. Continuing with our example, if an examinee was being assessed for the risk variable attitudes that support criminal behavior, and had a criminal history where he was once arrested for theft, and produced psychological testing that suggested low levels of criminal attitudes, there would only be two sources of information that weakly suggested the presence of the risk variable and consequently at 58 the score would be low. In contrast, if an examinee presented with 40 prior arrests for numerous different crimes, in addition to producing psychological testing that suggested strong criminal attitudes, coupled with his making statements during his interview glorifying criminal behavior, in addition to his being a member of a criminal organization, he would present with four sources all weighted as strongly indicating the presence of this risk variable, and at 58 his score would be high.

At 60, all the risk and protective variables are considered collectively, and a risk level (risk of reoffending) is determined at 62. Use of specialized tools between the steps of 60 and 62 is possible. Examples of the specialized tools which may be used at this step include the STATIC-99R, STABLE-2007, and HCR-20 V3; however, there are others that could also be utilized. The STATIC-99R is an actuarial scale that measures static risk variables and is designed to assist in the prediction of sexual offense recidivism, providing recidivism estimates based on groups of individuals who have been re-convicted for sexual offenses. The STABLE-2007 is also an instrument designed to assess risk of sexual reoffending, but in this case is done so through dynamic risk variables which have been identified as predictive of sexual offense recidivism. Both the STATIC-99R and STABLE-2007 provide scores that can be interpreted conjointly, and provide the examiner with an estimated risk to reoffend level. The HCR-20 V3 is a tool that considers an examinee's risk to reoffend by providing guidelines on how to analyze an examinee's history, characteristics of clinically-based factors, and consideration of available risk management sources, all of which are rooted in consideration of static risk variables, dynamic risk variables, and protective variables.

At 64, a risk to reoffend level is concluded by the examiner, which ranges from low to high risk to reoffend, with intermediate steps possible between such as low but upper end of low, moderate but low end of moderate, moderate, moderate but upper end of moderate, and high but lower end of high. The assignment of the risk to reoffend level is at the discretion of the examiner, based on the examiner's consideration of the totality of all the risk and protective variables, in addition to the severity and importance of all the variables, and also possibly consideration of specialized assessment tools.

Besides providing a risk to reoffend level, the system provides a traceable link to support, justify, and explain the evaluation process, with each risk and protective variable that contributed to the analysis being documented, and their weightings shown. The system also provides an assurance that all identified risk and protective variables have been considered.

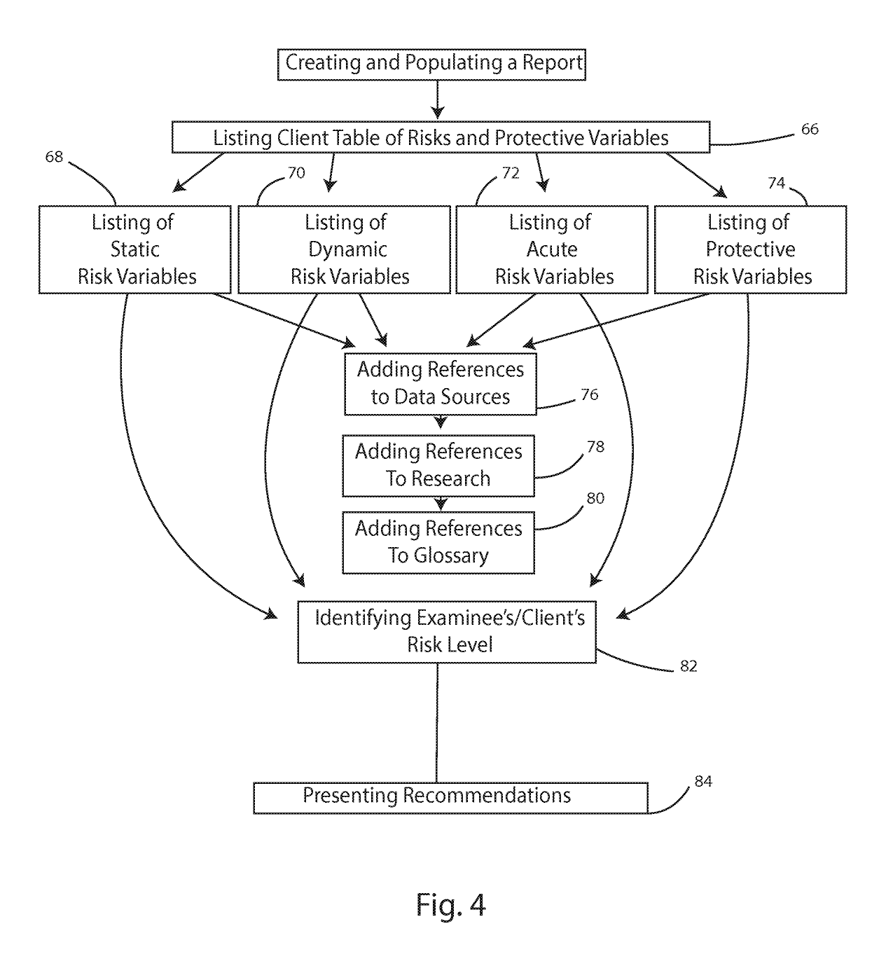

FIG. 4 shows the part of the method and system which entails creating and populating a report. The report can take many different configurations, but a preferred one is shown in FIG. 4. It begins with step 66, which is listing the risk and protective variables for a particular client. Each of these will have been identified as being relevant based on earlier information. These risk and protective variables are listed in discrete lists. At 68, each static risk variable, the ultimate weighted score for each static risk variable, the source(s), and the source(s) respective weighted score(s) for each static risk variable are listed. At 70, each dynamic risk variable, the ultimate weighted score for each dynamic risk variable, the source(s), and the source(s) respective weighted score(s) for each dynamic risk variable are listed. At 72, each acute risk variable, the ultimate weighted score for each acute risk variable, the source(s), and the source(s) respective weighted score(s) for each acute risk variable are listed. At 74, each protective risk variable, the ultimate weighted score for each protective variable, the source(s), and the source(s) respective weighted score(s) for each protective variable are listed.

At 76, references to the data sources which were considered and weighted in order to determine the risk or protective variables ultimate weighted scores are provided. This could include information from the examinee's interview or collateral sources. In the case of a digital version of the report, these could be hot links to these sources in the body of the report, allowing for quick reference in order to explain the presence and weighting of risk or protective variables.

At 78, reference to research are provided. In the case of a digital version of the report, these could be hot links to the names and authors of research articles, or the research articles themselves.

At 80, a glossary is assembled which is relevant to the risk variables, the protective variables, and technical terminology utilized in the report. If the system is used in digital form, the glossary definition of a word, term, or phrase could be accessed by a hot link, or in a paper version of the system could be displayed as footnotes or with a glossary section at the end of the report, or as a separate file or paper.

At 82, the client's risk level is determined based on consideration of all of the weighted risk and protective variables, in addition to possibly considering specialized assessment tools. A value indicating the client's overall risk to offend level is listed, as low, moderate, high, or intermediate levels. For anyone questioning how a particular risk value is determined, the supporting information can be reviewed, which provides transparency and accountability to the examiner's conclusions.

At 84, the examiner's recommendations are presented. This could include treatment and supervision recommendations, which are based on the examinee's risk to reoffend, and the potential nature of the offense.

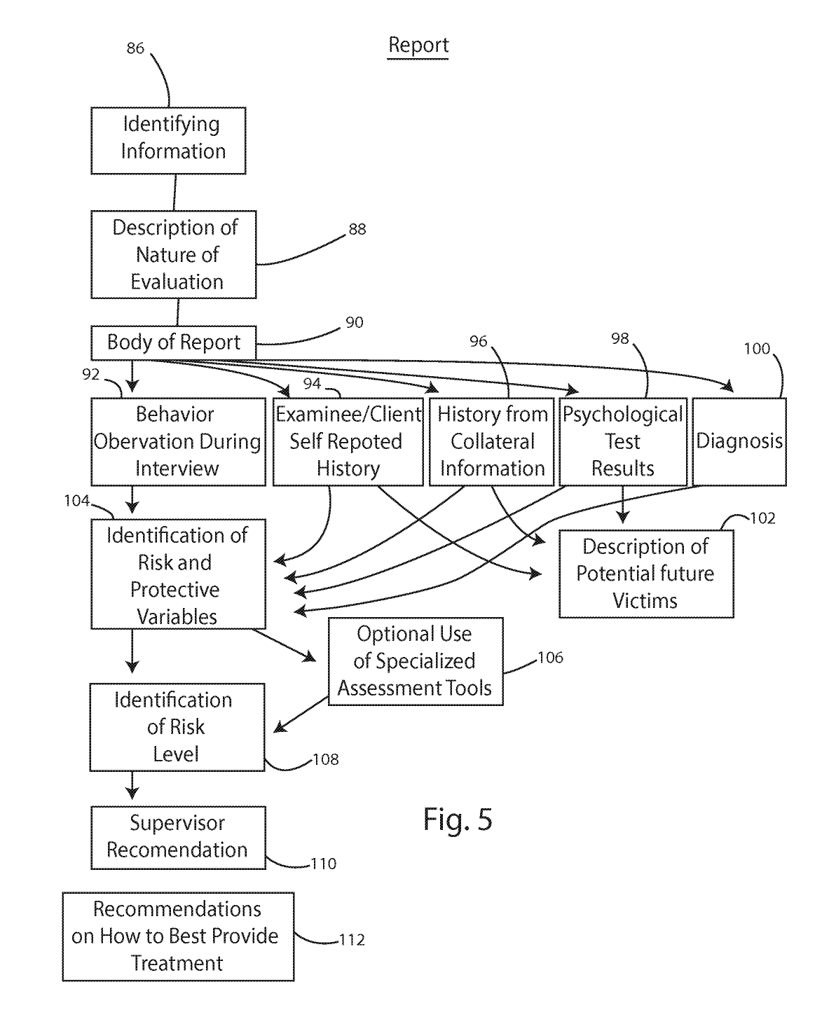

Shown in FIG. 5 is information which is preferably in the report for an examinee/client. 86 includes identifying information such as the client's name, date of birth, age, the case number, the defense attorney name, the prosecuting attorney name, the Judge name, and other identifying information. A date of the evaluation may also be included. At 88 a description of the nature of the evaluation is shown. Examples of this could be the type of evaluation, such as a “psychosexual evaluation” or “domestic violence evaluation”, or identifying the legal statutes followed in structuring the evaluation. 90 represents the body of the report. The body of the report can include the behavior observations during the interview of the client, 92. It can include the client's self reported history, 94. It can include history from collateral information, 96. It can include psychological test results, 98. And, it could also include diagnosis, 100. The client's self-reported history (94), history from collateral information (96), psychological test results (98), and diagnosis (100) can help an examiner identify potential future victims at 102. This could include males, females, prepubescent children, adolescents, adults, spouses, strangers, etc. At 104 is an identification of the risk variables and the protective variables. 106 includes the optional use of specialized assesment tools, which are discussed above. At 108 the examinee's risk to reoffend levels is identified. This can include the designation of low, moderate, and high, as discussed above, or intermediates of those descriptors. At 110 is included recommendations on how to best supervise an examinee if he were not incarcerated and residing in the community. The supervisor is typically a probation officer or parole officer, but may include other individuals. Recommendations can use the analytical system presented to provide specific guidance on how to supervise the examinee in such a way to prevent a future criminal act, and protective the public. For example, if an examinee has been determined to be a risk to engage in sexual behavior with children, his supervisor would not permit the examinee to work at a day care, but may not be concerned if the examinee worked in a warehouse. At 112 is included recommendations on how to best provide treatment to the examinee. This may include recommendations regaring the type of treatment, such as substance use treatment, anger management, sexual offender treatment, medication use, etc. This may also include advise regarding the focus of treatment, such as focusing on addressing the exmainee's dynamic risk variables and enhance the examinee's protective variables.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. A method of evaluating risk of reoffending of criminal behavior, comprising the steps of:
creating a comprehensive table of risk variables, said comprehensive table for use by an examiner for identifying applicable risk variables in a particular examinee;
presenting questions useful in determining the presence of the risk variables in the said table of risk variables to said examinee, and obtaining responses to each question in order to determine the presence of risk variables, in an interview;
collecting and analyzing collateral information on client behavior and history;
populating a client table of risk variables for a particular examinee with positive indicators of risk variables, based on information from said interview and from collateral sources;
analyzing each source of information for each risk variable identified from said interview, and from collateral sources, and assigning a weighting score that represents the importance or severity of each source of information;
recording said weighting score for each source of information;
consider all the weighting scores from each source of information for each respective risk variable and determining a cumulative ultimate weighting score for each risk variable;
recording said ultimate weighting score for each risk variable;
consider all ultimate weighting scores collectively for all risk variables to determine a client's risk to reoffend with the criminal behavior being analyzed; and
populating a report with information relating to risk of client reoffending.

2. The method of evaluating risk of reoffending of criminal behavior of claim 1 which further comprises the steps of listing the risk variables, the sources of the risk variables, and the weighting score of each source and of a cumulative ultimate weighting score for each respective risk variable to said report.

3. The method of evaluating risk of reoffending of criminal behavior of claim 1 which further comprises the step of adding a rating of a client's risk to reoffend to said report.

4. The method of evaluating risk of reoffending of criminal behavior of claim 1 which further comprises the step of adding treatment and supervision recommendations to said report.

5. The method of evaluating risk of reoffending of criminal behavior of claim 1 which further comprises the step of weighting the sources of information of said risk variables based on the significance of the positive indicators.

6. The method of evaluating risk of reoffending of criminal behavior of claim 1 in which said step of populating a report includes listing risk variables in the category of static and dynamic risk factors.

7. The method of evaluating risk of reoffending of criminal behavior of claim 1 which further comprises the step of reviewing collateral sources of information from the list comprising police reports, criminal history, witness statements, hospital records, character references, and psychological testing.

8. The method of evaluating risk of reoffending of criminal behavior of claim 1 which further comprises the step of adding acute dynamic risk variables to said table of risk variables, and populating said acute risk variables with positive indicators for a particular client.

9. The method of evaluating risk of reoffending of criminal behavior of claim 1 which further comprises the step of adding protective variables to said table of risk variables, and populating said protective variables with positive indicators for a particular client.

10. A system of evaluating risk of reoffending of criminal behavior, comprising:
a table of risk variables providing a comprehensive list of risk variables relating to risk to reoffend that have been established through empirical research;
a table of static risk variables compiled by an examiner for a particular examinee, with said static risks variables consisting of examinee specific information which are commonly historical in nature, and unchangeable, with said static risk variables obtained from contributing sources;
a table of dynamic risk variables compiled by an examiner for a particular examinee, comprised of stable characteristics, which are unlikely to change without intervention, with said dynamic risk variables obtained from contributing sources;
a list of sources of information that are positive indicators for each identified static and dynamic risk variable for a particular examinee, with each source of information assigned a weighting score that weights the importance or severity;
an analysis by the examiner of all the sources of information and respective weights of severity or importance for each source of information for each said risk variable, with the analysis to determine a cumulative weighting for each risk variable;
an analysis by the examiner of all cumulative weightings for each said risk variable, with the analysis to determine risk to reoffend, conclusions, and recommendations;
a report which lists risk variables, weightings of sources of information, and a linkage path between each risk variable and their respective weighted sources of information which determine the presence of the risk variable; and
populating a report with information relating to risk of client reoffending.

11. The system of evaluating risk of reoffending of criminal behavior of claim 10, which further comprises a table of acute dynamic risk variables, comprised of situations or characteristics that can suddenly develop for an examinee and rapidly increase risk to reoffend, with said acute risk variables obtained from contributing sources.

12. The system of evaluating risk of reoffending of criminal behavior of claim 10, which further comprises a table of protective variables, comprised of characteristics, circumstances, or achievements of an examinee that can reduce risk to reoffend, with said protective variables obtained from contributing sources.

13. The system of evaluating risk of reoffending of criminal behavior of claim 10, which further comprises weighting sources of information for each risk variable, to indicate a weighting to be applied to each source of information, reflective of the importance or severity of each source of information, with said weighting for application to assess the overall importance or severity of each risk variable represented in a cumulative weighting, and an overall assessment of risk to reoffend.

14. The system of evaluating risk of reoffending of criminal behavior of claim 10, in which said contributing sources of information is selected from the group consisting of an examinee interview, a questionnaire filled out by an examinee, psychological test results, police reports, criminal history, hospital records, letters by persons knowledgeable about the examinee, and witnesses to the examinee's behavior.

15. The system of evaluating risk of reoffending of criminal behavior of claim 10, in which said static risk variables are selected from the group consisting of age, history of criminal behavior, history of major mental illness, characteristics of prior victims, family of origin history, employment history, school history, affiliation history, and other information which are pertinent to a particular examinee.

16. The system of evaluating risk of reoffending of criminal behavior of claim 10, in which said dynamic risk variables are selected from the group consisting of anger issues, poor impulse control, poor insight, active substance use issues, victim blaming, minimization of criminal behavior, attitudes supporting criminal behavior, beliefs that support the manipulation of others, rejection of treatment, rejection of supervision, and other information which are pertinent to a particular examinee.

17. The system of evaluating risk of reoffending of criminal behavior of claim 10, in which said acute dynamic risk variables are selected from the group consisting of access to potential victims, surges in hostility, collapse of social support, active abuse of substances, and other information which are pertinent to a particular examinee.

18. The system of evaluating risk of reoffending of criminal behavior of claim 12, in which said protective variables are selected from the group consisting of absence of a serious criminal history, pro-social attitudes, good social skills, financial responsibility, a positive employment history, skills at managing emotions, successful completion of treatment, successful completion of probation/parole, and other information which are pertinent to a particular examinee.

19. The system of evaluating risk of reoffending of criminal behavior of claim 10 which further comprises treatment and supervision recommendations.
